(19) United States
(12) Patent Application Publication
(10) Pub. No.: US 2021/0108396 A1
(43) Pub. Date: Apr. 15, 2021

(54) Mobile Atmospheric Water Generation System

(71) Applicant: Ryan Bromley, San Diego, CA (US)

(72) Inventor: Ryan Bromley, San Diego, CA (US)

(21) Appl. No.: 16/601,756

(22) Filed: Oct. 15, 2019

(51) Int. Cl. E03B 3/28; B01D 46/00; B01D 46/24; B01D 46/42; B01D 53/26; H01M 10/46; H01M 10/42; C02F 1/32

(52) U.S. Cl. CPC E03B 3/28; B01D 46/0023; B01D 46/2418; B01D 46/4263; B01D 46/4245; B01D 53/265; C02F 2201/009; H01M 10/4264; C02F 1/325; B01D 2279/40; H01M 2220/10; C02F 2303/04; H01M 10/465

(57) ABSTRACT

A method and system are disclosed for atmospheric water generation (AWG) via a system which includes a compressor-condensor-evaporator subsystem and a refrigerant circulated in a closed-loop there through, a reconfigurable moist air input plenum and a dry air output plenum, a first stage large particulate air filter and a subsequent stage honeycomb ceramic micro particulate air filter, an air precooler configured to mix cooled air with warm intake air, and a folding solar power array configured to fold up in a cuboid around the AWG system for transportation and storage and lay flat in a chosen direction facing the sun.

### BACKGROUND OF THE INVENTION

An atmospheric water generator (AWG) is a device that extracts water from humid ambient air. Water vapor in the air can be extracted by condensation—cooling the air below its dew point, exposing the air to desiccants, or pressurizing the air. Unlike a dehumidifier, an AWG is designed to render the water potable. AWGs are useful where pure drinking water is difficult or impossible to obtain, because there is almost always a small amount of water in the air that can be extracted. The two primary techniques in use are cooling and desiccants.

The extraction of atmospheric water can require a significant input of energy. Some AWG methods are completely passive, relying on natural temperature differences, and requiring no external energy source. Biomimicry studies have shown the beetle Stenocara gracilipes has the natural ability to perform this task.

### SUMMARY OF THE DISCLOSURE

A disclosed atmospheric water generator (AWG) system includes a compressor-condensor-evaporator subsystem and a refrigerant circulated in a closed-loop there through, a reconfigurable moist air input plenum and a dry air output plenum, a first stage large particulate air filter and a subsequent stage honeycomb ceramic micro particulate air filter, an air precooler configured to mix cooled air with warm intake air, and a folding solar power array configured to fold up in a cuboid around the MAWG system for transportation and storage and lay flat in a chosen direction facing the sun.

A method is disclosed for atmospheric water generation includes circulating a refrigerant through a compressor-condensor-evaporator subsystem in a closed-loop, moving an airflow through a reconfigurable moist air input plenum and a dry air output plenum, filtering the airflow via a first stage large particulate air filter and a subsequent stage honeycomb ceramic micro particulate air filter, mixing a precooled air precooler with a warmer intake air, and configuring a foldable solar power array flat in a chosen direction facing the sun for energy generation and in a cuboid around the AWG system for transportation and storage.

### BRIEF DESCRIPTION OF DRAWINGS

FIG. 1 depicts a power intake unit with adjustable sides for the mobile atmospheric water generation system in accordance with the present invention.

FIG. 2 depicts a configurable intake plenum for the mobile atmospheric water generation system in accordance with an embodiment of the present invention.

FIG. 3 depicts a folded out solar panel array for the mobile atmospheric water generation system in accordance with the present invention.

FIG. 4 depicts a multistage air filtration system comprising an intake plenum, a paper prefilter, a five component honeycomb ceramic filter and an activated charcoal filter in accordance with the present invention.

FIG. 5 depicts high level electrical schematic details including an electric motor, a refrigerant compressor and an electric generator in accordance with an embodiment of the present disclosure.

FIG. 6A depicts the mobile atmospheric water generation system level schematic in a top view pictorial per legend in accordance with an embodiment of the present disclosure.

FIG. 6B depicts the mobile atmospheric water generation system level schematic in a side view pictorial per legend in accordance with an embodiment of the present disclosure.

FIG. 6C depicts the mobile atmospheric water generation system level schematic in a front view pictorial per legend in accordance with an embodiment of the present disclosure.

FIG. 7 is a flow diagram of steps of a method for atmospheric water generation in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure the term ‘regulate’ is used in the common sense to control or to maintain an electrical characteristic or property. The term ‘plenum,’ is used in the common sense for an enclosed space used to collect air completely filled with air flow.

A mobile atmospheric water generation system filters carbon emissions from the air, while creating clean drinkable water. This unit IS powered by a 20 hp electric motor that runs a refrigeration unit necessary to create water generation from the humidity in the air. Power for the system is primarily provided by solar panels on top of the unit for power generation. All electricity will be stored in a battery pack, and can be converted to a/c through an onboard inverter.

The water collected will pass through an activated charcoal filter into a collection tank. While in the tank, the water will be circulated through ultra violet light to prevent bacteria growth. Air filtration is performed by a 4 multistage ceramic and activated charcoal filters. The ceramic filters are designed so once the filters are full, they can be removed and baked in a standard diesel particulate filter oven.

Possible uses for this unit include disaster relief, agriculture, smog reduction, drought relief, fresh water and electric power supply in developing countries. This unit will be vehicle mounted for mobility, and does not create harmful emissions.

Powered by solar, wind, and an onboard battery bank, this unit condenses moisture in the air into clean safe drinking water, while being a reliable power source, and filtering carbon emissions and other pollutants from the air via multi stage air filtration system. Storing clean water and energy onboard with the ability to interconnect units to create a large clean water/power plant. Units can be used for drought relief with farming, wildlife, in cities on sky scrapers allowing less extensive transmission/transport of water and power. units can also be truck mounted to be utilized for mobile water/power generation in developing countries or stationary to create a long term sustainable grid in places like Puerto Rico. This unit is great for hotter environments that stay above freezing, and get more sunlight.

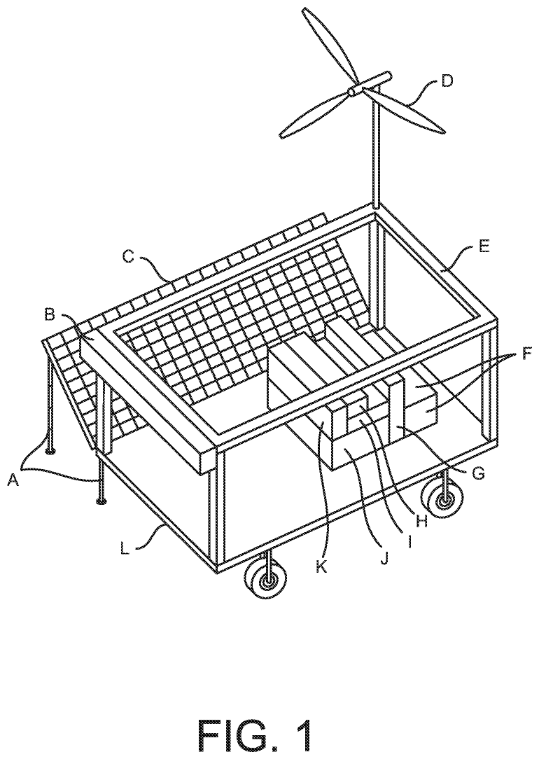

FIG. 1 depicts a power intake unit with adjustable sides for the mobile atmospheric water generation system in accordance with the present invention. The depiction includes telescopic support bars A, refrigeration system and electric motor mount on the top front of unit B, solar panels which slide up and lock into place on top of frame work C, detachable wind turbine D, framework to hold solar panels E, battery packs F, UV (ultraviolet) light sterilization unit G, water pump and filtration system H, secondary water tank I, main water tank J, 5′×5′ electric fan, and skid mount for attaching to a truck or stationary operation L. The disclosed unit is powered by a solar panel array C and an onboard electric generator. Sides, and rear of the system fold down to reveal protected solar panels. Once folded out, the solar panels are hoisted in place using a hand operated ratcheting crank system along vertical roller channels. Once in place, side walls lock into a safety latch. Side wall locks are in place front and rear for wall storage and transportation. Four support bars A on the input plenum adjust for maximum solar power or wind power collection. A side panel adjustment for the most effective angle is reached by gear driven adjustable support bars. This adjustment allows for maximum solar power collection.

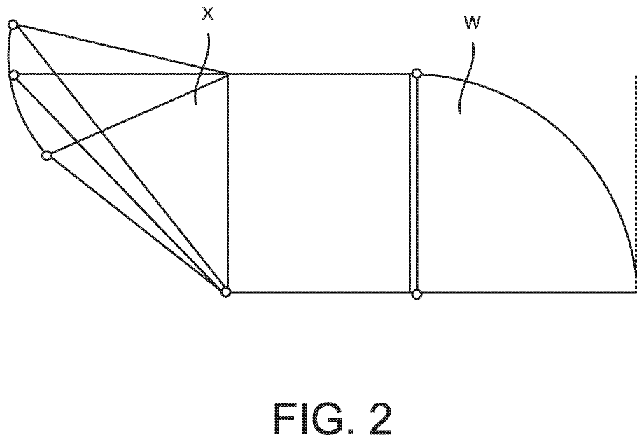

FIG. 2 depicts a configurable intake plenum for the mobile atmospheric water generation system in accordance with an embodiment of the present invention. The depiction includes the configurable intake plenum X and the air intake pipe W adjacent thereto. The configurable intake plenum is shown in 3 possible configurations but others are included to match wind direction, wind speed and air intake needs.

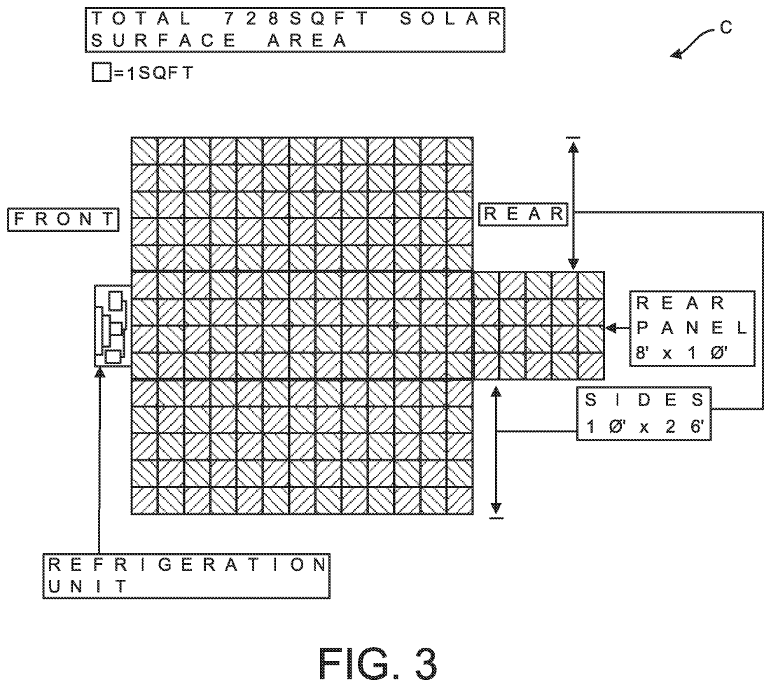

FIG. 3 depicts a folded out solar panel array for the mobile atmospheric water generation system in accordance with the present invention. The depiction includes solar panels C in a flat configuration including a rear panel (right of vertical demarcation), two side panels (top and bottom of horizontal demarcations) and a refrigeration unit. Solar power is stored in 2 large battery packs located in the rear of the unit. Power is then routed though an inverter and capacitor, then to the front of the unit. Once power reaches the 20 horsepower electric drive motor, the motor turns the refrigeration compressor, along with an electric generator. The generator supplies additional power to battery packs.

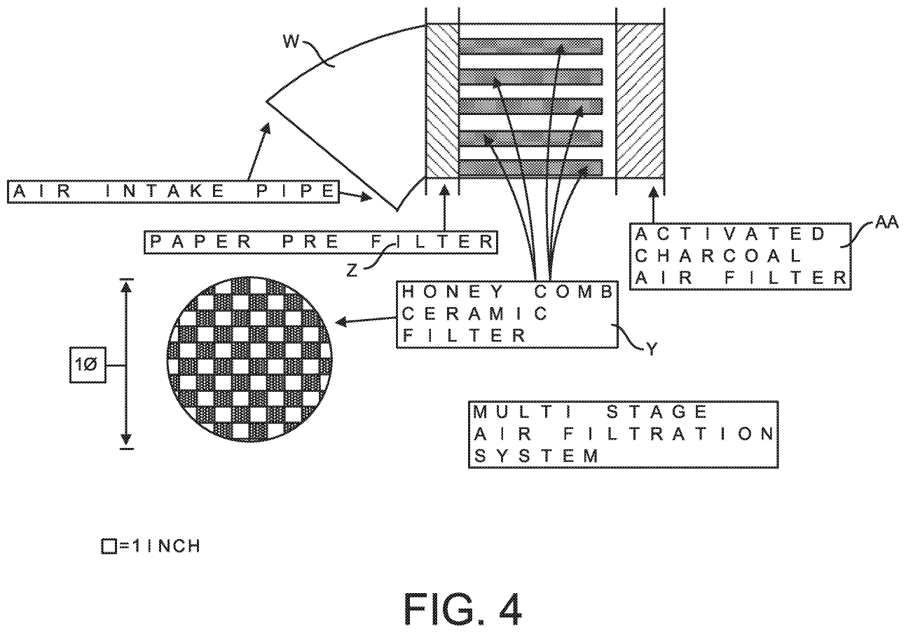

FIG. 4 depicts a multistage air filtration system comprising an intake plenum W, a paper prefilter Z, a five component honeycomb ceramic filter Y and an activated charcoal filter AA in accordance with the present invention. Once the refrigeration system is functioning, it begins to cool the 640 feet insulated air cooling compartment once cooling compartment is at proper temperature, external air is pulled through a multistage air filtration system, into the air cooling system. This is done through two 10 inch cold air intake pipes at the front of the unit. The air is then forced through high flow air coolers. Seven high flow air coolers are stacked vertically in the refrigerated compartment, with 6 cold refrigerated condensors in between for added cooling. Once the air is cooled, it leaves the air cooler compartment via two 6 inch pipes, through the rear bulkhead of the insulated compartment.

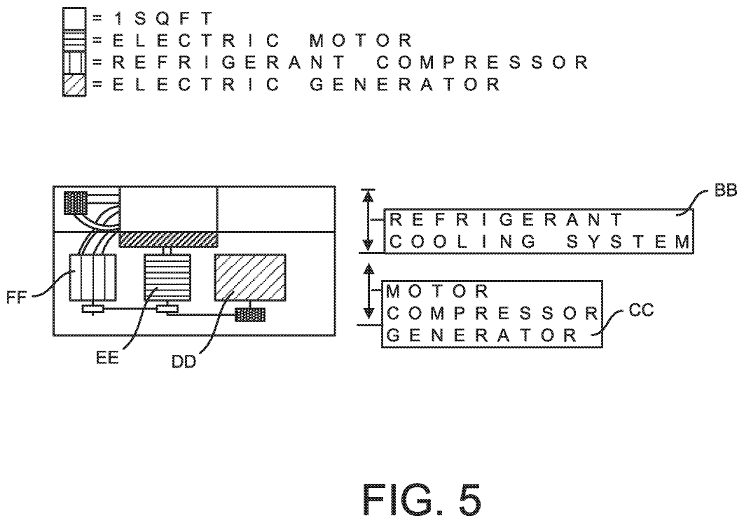

FIG. 5 depicts high level electrical schematic details including an electric motor, a refrigerant compressor and an electric generator in accordance with an embodiment of the present disclosure. The motor-compressor-generator cluster CC includes the electric generator DD and the electric motor EE which runs the refrigerant compressor FF which runs the refrigerant compressor cooling system BB including the evaporator, compressor, condensor and expansion valve(s).

Once out of the insulated compartment, the pipes enter the condensation compartment. At this stage, the 6 inch pipes open into 10 inch pipes, allowing for expansion of the cold air before entering 5 vertically stacked high air flow condensors. Warm air is then pulled over the condensors. From two 10 inch warm air intake pipes, warm air intake pipes use the same multistage air filtration system as the cold air intake. The heat exchange from the cold air inside the condensors, with the external warm air allows for maximum condensation collection. Dried/filtered air is then exhausted via two exhaust ports on either side of the unit, just behind the condensation compartment.

Condensation is collected in the bottom or the rubber coated condensation compartment. As water collects, it drains through a one way valve through an activated carbon filter, into the primary holding tank. Inside the tank, the water is circulated past ultra violet lights. This circulation prevents stagnation of the water. The UV light prevents bacteria growth once the primary holding tank has reached capacity of 430 gallons, water is automatically pumped to the onboard 120 gallon secondary holding tank. This tank has the same water circulation UV light system. Once water is ready to be used, it is pumped out of the holding tanks through a final activated carbon filter to ensure cleanest drinking water possible.

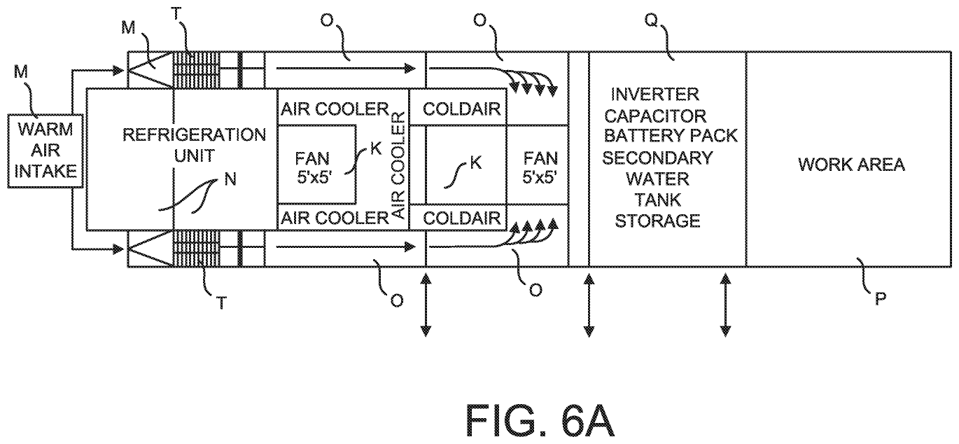

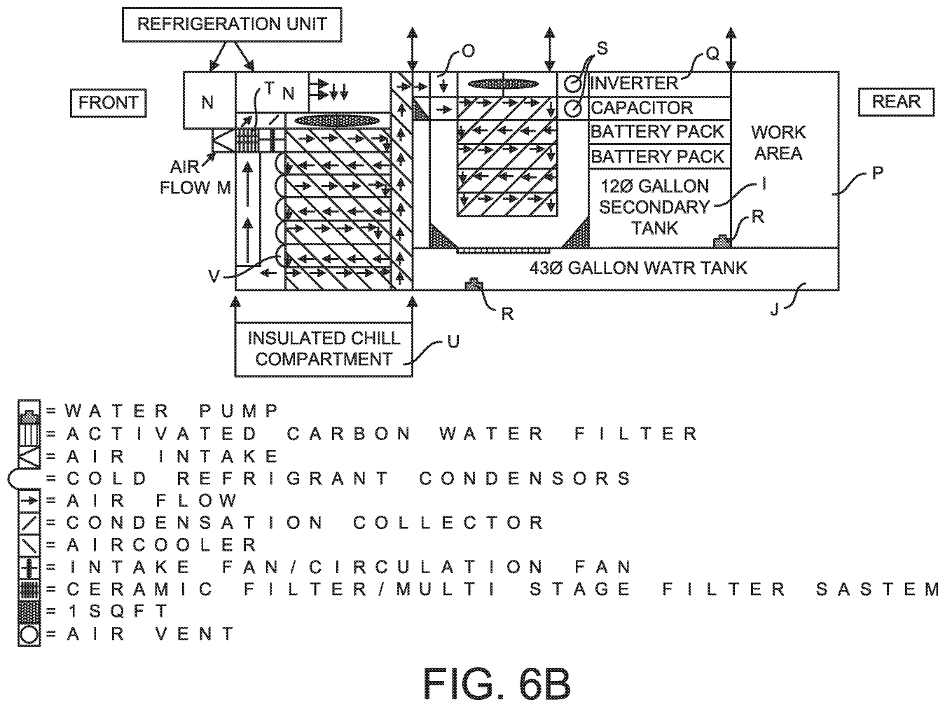

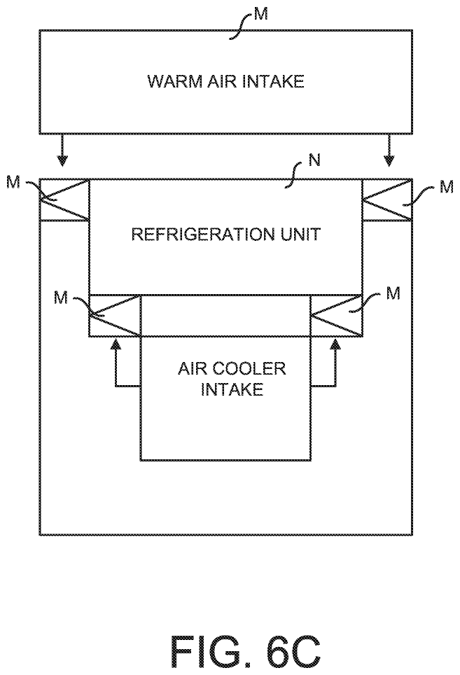

FIG. 6A depicts the mobile atmospheric water generation system level schematic in a top view pictorial per legend in accordance with an embodiment of the present disclosure. The top view depiction includes a warm air intake M, refrigeration units N, two series air cooler fans K, an inverter, capacitor, battery pack and secondary water tank storage Q and a work area P. Air flow is denoted O and ceramic filters are shown in place by T.

FIG. 6B depicts the mobile atmospheric water generation system level schematic in a side view pictorial per legend in accordance with an embodiment of the present disclosure. The depiction includes an air intake plenum M, an insulated chill compartment and air cooler N which feeds chilled air into the condensation collector per legend. The side view depiction also includes an inverter, capacitor and battery pack energy storage Q and 120 gallon secondary water tank I and a 430 gallon primary water tank J and the work area P. Water pumps R are indicated as are air vents S per legend, a circulation fan per legend, the activated carbon water filter per legend and the ceramic filter T are also depicted. Air flow is referenced O and an insulated chill compartment U is shown and a cold refrigerant condensor V is shown.

FIG. 6C depicts the mobile atmospheric water generation system level schematic in a front view pictorial per legend in accordance with an embodiment of the present disclosure. The front depiction includes the warm air intake plenum M, the air cooler intake per legend and the refrigeration unit N with indicated air flow from the warm air intake to the intake of the refrigeration unit N.

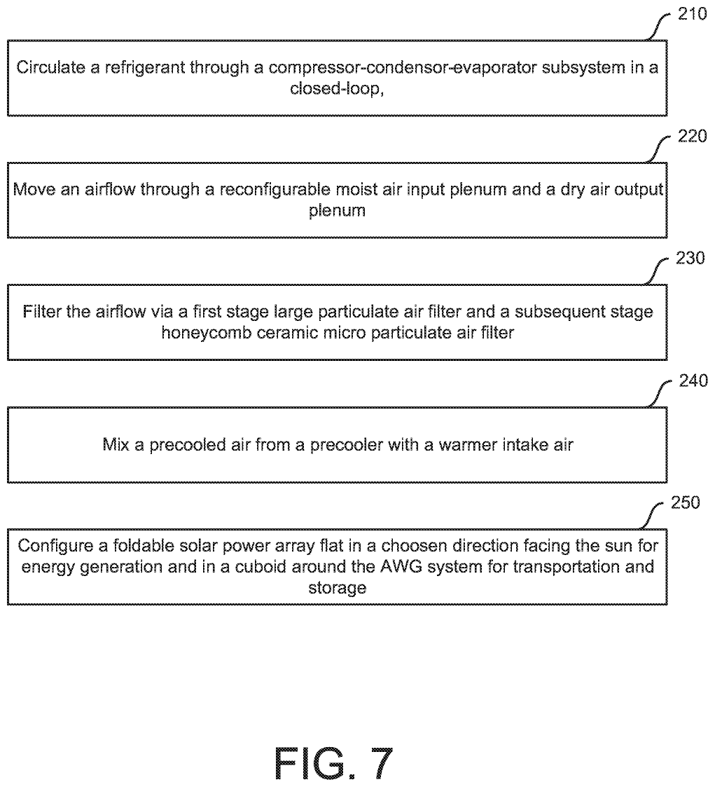

FIG. 7 is a flow diagram of steps of a method for atmospheric water generation in accordance with an embodiment of the present disclosure. The method includes circulating 210 a refrigerant through a compressor-condensor-evaporator subsystem in a closed-loop, moving 220 an airflow through a reconfigurable moist air input plenum and a dry air output plenum, filtering 230 the airflow via a first stage large particulate air filter and a subsequent stage honeycomb ceramic micro particulate air filter, mixing 240 a precooled air precooler with a warmer intake air, and configuring 250 a foldable solar power array flat in a chosen direction facing the sun for energy generation and in a cuboid around the AWG system for transportation and storage.

This unit solves 3 major issues in the world. Clean and safe drinking water, growing air pollution, and lack of reliable electricity in developing countries. Applications for this unit include agriculture, military, disaster relief, smog reduction, drought relief, and sustainable water/energy source in developing countries. This unit can help with crop retention, with the ability.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention.

The instant invention has been shown and described in what it considers to be the most practical and preferred embodiments. It is recognized, however, that departures may be made there from within the scope of the invention and that obvious modifications will occur to a person skilled in the art.

What is claimed is:

1. An atmospheric water generator (AWG) system, comprising;
a compressor-condensor-evaporator subsystem and a refrigerant circulated in a closed-loop there through;
a reconfigurable moist air input plenum and a dry air output plenum;
a first stage large particulate air filter and a subsequent stage honeycomb ceramic micro particulate air filter;
an air precooler configured to mix cooled air with warm intake air; and
a folding solar power array configured to fold up in a cuboid around the AWG system for transportation and storage and lay flat in a chosen direction facing the sun.

2. The AWG system of claim 1, wherein the air precooler further comprises warm air intake pipes and a heat exchanger to mix cold air inside the condensors with external warm air for maximum condensation collection.

3. The AWG system of claim 1, further comprising a first stage air circulation fan and a subsequent stage air circulation fan.

4. The AWG system of claim 1, further comprising a water pressure pump.

5. The AWG system of claim 1, wherein the reconfigurable most air input plenum further comprises four support bars per side.

6. The AWG system of claim 1, wherein the foldable solar power array further comprises vertical roller channels configured to facilitate arranging the flat direction facing the sun.

7. The AWG system of claim 1, further comprising a plurality of interconnected AWG systems configured to deliver a larger volume of water and electrical power.

8. The AWG system of claim 1, wherein the ceramic honeycomb micro particulate air filters further comprise an ability to bake off particulates in a filter oven.

9. The AWG system of claim 1, further comprising an electricity storage battery bank including an alternating current inverter and capacitor.

10. The AWG system of claim 1, further comprising a first stage large particulate carbon water filter and a subsequent stage activated carbon water filter for the collected water condensate.

11. The AWG system of claim 1, further comprising a plurality of water holding tanks configured to collect water condensate from the evaporator and circulate the water in exposure to an UV (ultraviolet) light.

12. The AWG system of claim 1, further comprising a plurality of side wall locks in a front, sides and rear of the AWG system for wall securement and transportation of the AWG system.

13. The AWG system of claim 1, further comprising a supplemental electricity generator 10 and an electric motor configured to supply power to the AWG system.

14. The AWG system of claim 1, wherein the air precooler further comprises a thermostat configured to mix signal a duct switch from recirculating cooled air to mixing with warm intake air.

15. The AWG system of claim 1, further comprising a work area configured for maintenance activities of the AWG system.

16. The AWG system of claim 1, further comprising hoisting points on the enclosed cuboid for temporary portability to and on a truck.

17. The AWG system of claim 1, further comprising a plurality of ports in the primary and secondary water tanks, the ports configured for inter and intra connectivity to other tanks.

18. A method for Atmospheric Water Generation (AWG), the method comprising;
circulating a refrigerant through a compressor-condensor-evaporator subsystem in a closed-loop;
moving an airflow through a reconfigurable moist air input plenum and a dry air output plenum;
filtering the airflow via a first stage large particulate air filter and a subsequent stage honeycomb ceramic micro particulate air filter;
mixing a precooled air precooler with a warmer intake air; and
configuring a foldable solar power array flat in a chosen direction facing the sun for energy generation and in a cuboid around the AWG system for transportation and storage.

19. The method for AWG of claim 17, further comprising configuring the moist air input plenum and the dry air output for connection to another AWG system.

20. The method for AWG of claim 17, further comprising interconnecting an electrical, a mechanical and a hydraulic portion of one AWG system with a plurality of other AWG systems.
